(19) United States
(12) Patent Application Publication
(10) Pub. No.: US 2009/0077222 A1
(43) Pub. Date: Mar. 19, 2009

(54) KVM SWITCH AND MULTI-COMPUTER SYSTEM INCORPORATING THE SAME

(75) Inventors: Hsin-Mao Shen, Taipei (TW); Chao-Hsuan Hsueh, Taipei (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: ATEN INTERNATIONAL CO., LTD., Taipei (TW)

(21) Appl. No.: 11/854,655

(22) Filed: Sep. 13, 2007

(51) Int. Cl. G06F 13/38; G06F 15/173; G06F 3/041

(52) U.S. Cl. 709/224; 345/173; 709/223; 710/36; 710/38

(57) ABSTRACT

The invention discloses KVM switches comprising a body, a data transceiver, a micro control unit, and a display disposed on the body. The data transceiver receives data from a plurality of computers. The micro control unit analyzes and operates the received data to generate an image. The image may show data from all computers in chorus. The display displays the image. The data provided by the computers are generated by application programs of the computers. The application program may retrieve system information of the corresponding computer as the data, retrieve discs of the corresponding computer to get the data, or download information from the internet as the data.

### BACKGROUND OF THE INVENTION

1. Field of the Invention

The invention relates in general to KVM switches, and more particularly to KVM switches displaying system information of computers connected thereto and a multi-computer system incorporating the same.

2. Description of the Related Art

A KVM switch (with KVM being an abbreviation for Keyboard, Video, and Mouse) is a hardware device that allows a user to control multiple computers from a single keyboard, video monitor and mouse. FIG. 1 shows the block diagram of a conventional multi-computer system. A console comprises a video monitor 102, a keyboard and a mouse (abbreviated as KB/MS 104), and an audio device 106. A KVM switch 108 controls the signal transmission between the devices of the console (102-106) and a plurality of computers (110 and 112). The KB/MS 104 inputs commands to control computer 1 (110) or computer 2 (112). The controlled computer (110 or 112) works according to the commands and outputs video and audio signals to the video monitor 102 and the audio device 106, respectively. In conventional techniques, a user can only communicate with one of the computers (110 or 112) via the devices of the console.

### BRIEF SUMMARY OF THE INVENTION

The invention discloses KVM switches comprising a body, a data transceiver, a micro control unit, and a display disposed on the body. The data transceiver receives data from a plurality of computers. The micro control unit analyzes and operates the received data to generate an image. The display displays the image. The data transceiver may communicate with the computers via a USB protocol, a wireless protocol, or a serial protocol.

The data provided by the computers are generated by application programs of the computers. In some embodiments, the application program retrieves system information of the corresponding computer as the data. The system information may be CPU loading, CPU temperature, fan rotation, disc information, time, or date. The image displayed by the display is a list of the system information. In some embodiments, the application program retrieves discs of the corresponding computer to get the data. The data retrieved from the discs may be photos, emails, notes, or address books. In some embodiments, the application program downloads information from the internet as the data. The downloaded information may be the weather report or stock quotes.

In some embodiments, the micro control unit further generates an on-screen display (OSD) to be displayed by the display.

In some embodiment, the display is a touch panel. The micro control unit receives commands from the touch panel and transmits the commands to the computers. A user can communicate with the computers directly by the KVM switch of the invention without using the devices of the console (such as the video monitor, the KB/MS and the audio device).

The invention further discloses multi-computer systems utilizing the KVM switch of the invention. In addition to the KVM switch of the invention, the multi-computer system comprises a plurality of computers each comprising a data terminal for coupling to the data transceiver of the KVM switch.

The invention further discloses KVM switches comprising a body, a display disposed on the body, a micro control unit, and a display driver. The micro control unit generates an on-screen display (OSD). The display driver is coupled between the micro control unit and the display to drive the display to show the OSD.

The above and other advantages will become more apparent with reference to the following description taken in conjunction with the accompanying drawings.

### BRIEF DESCRIPTION OF THE DRAWINGS

The invention can be more fully understood by reading the subsequent detailed description and examples with references made to the accompanying drawings, wherein:

FIG. 1 shows a block diagram of a conventional multi-computer system;

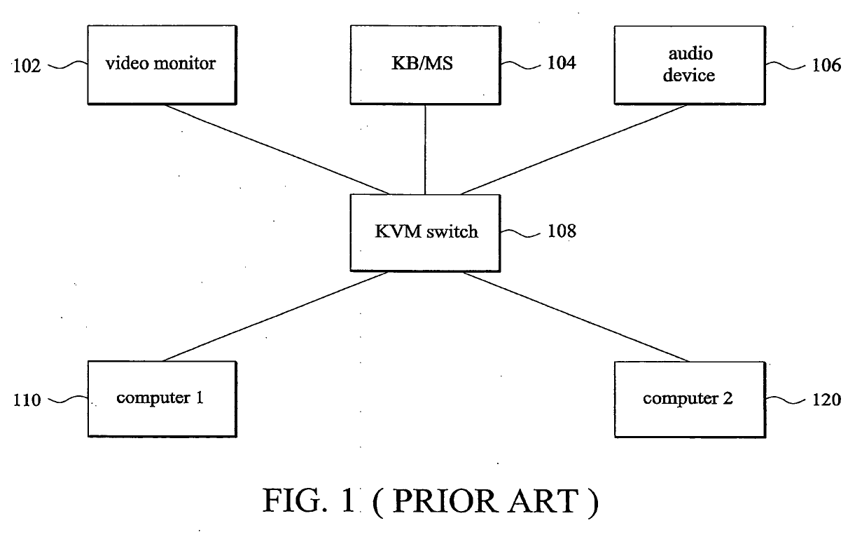

FIG. 2 shows a block diagram of a multi-computer system utilizing the KVM switch of the invention; and

FIG. 3 illustrates a structure of the KVM switch of the invention.

### DETAILED DESCRIPTION OF THE INVENTION

The following description is made for the purpose of illustrating the general principles of the invention and should not be taken in a limiting sense. The scope of the invention is best determined by reference to the appended claims.

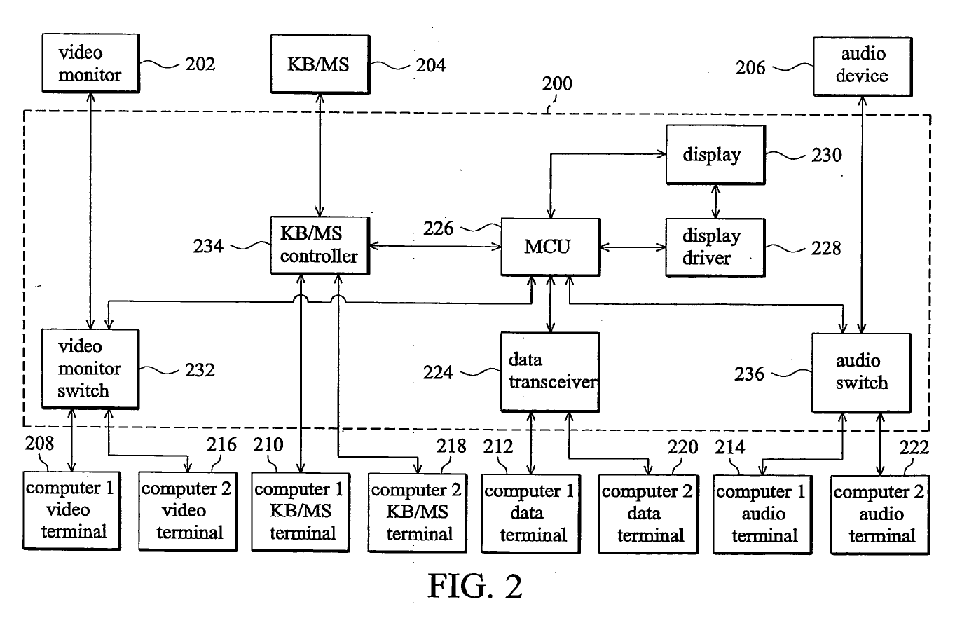

FIG. 2 shows a block diagram of a multi-computer system utilizing a KVM switch of the invention. The console comprises a video monitor 202, a keyboard and a mouse (abbreviated as KB/MS 204), and an audio device 206. In this example, there are two computers (computer 1 and computer 2). The console controls the computers via the KVM switch 200. In conventional multi-computer systems, the computers each comprise a video terminal outputting a video signal, KB/MS terminals outputting KB/MS signals, and an audio terminal outputting an audio signal. Compared to conventional multi-computer systems, the computers of the invention each further comprise a data terminal outputting data. In the embodiment shown in FIG. 2, computer 1 comprises a video terminal 208, KB/MS terminals 210, a data terminal 212, and an audio terminal 214. Computer 2 comprises a video terminal 216, KB/MS terminals 218, a data terminal 220, and an audio terminal 222. The KVM switch 200 comprises a video monitor switch 232, a KB/MS controller 234, and an audio switch 236. The video monitor switch 232 controls and routs the connection between the video monitor 202 and the video terminals of the computers (208 and 216) to set the video source of the video monitor 202. The audio switch 236 controls and routs the connection between the audio device 206 and the audio terminals of the computers (214 and 222) to set the audio source of the audio device 206. The KB/MS controller 234 controls the connection between the KB/MS 204 and the KB/MS terminals of the computers (210 and 218) to set the KB/MS source of the KB/MS 204. The video monitor switch 232 and the audio switch 236 electrically switch the circuit connections. For the KB/MS controller 234, instead of electrically switching the circuit connection, the KB/MS controller 234 simulates the behavior of the KB/MS 204, continually transmitting information of the connections of the KB/MS 204 to the computers, because the computers have to always be connected with a keyboard and a mouse during operation. In one embodiment, the audio device 206 may be a speaker or a socket port electrically inserted by an earpiece.

Referring to FIG. 2, the KVM switch 200 comprises a data transceiver 224, a micro control unit (MCU) 226, a display driver 228, and a display 230. The data transceiver 224 receives data from the computers (computer 1 and computer 2) via the data terminal of computer 1 (212) and the data terminal of computer 2 (220). The data transceiver 224 may communicate with the computers (computer 1 and computer 2) via a USB protocol, a wireless protocol, or a serial protocol. The micro control unit 226 analyzes and operates the received data to generate an image. The display driver 228 is coupled between the micro control unit 226 and the display 230 to drive the display 230 to display the image generated by the micro control unit 226. The image may show data from all computers in chorus. In one embodiment, the MCU 226 and the display driver 228 may be integrated into a processing circuit or an ASIC.

The computers (computer 1 and computer 2) each comprises at least one application program generating the data. In some embodiments, the application program retrieves system information of the corresponding computer as the data. The system information may be CPU loading, CPU temperature, fan rotation, disc information, time, or date. The image may show the system information of the computers in a list.

In some embodiments, the application program retrieves discs of the corresponding computer to get the data. The data retrieved from the discs may be photos, emails, notes, or address books. The micro control unit 226 generates an image comprising the retrieved data and the display driver 228 drives the display 230 to show the image.

In some embodiments, the application program downloads information from a network database in the network as the data. The downloaded information may be the weather report or stock quotes. The micro control unit 226 generates an image comprising the information and the display driver 228 drives the display 230 to show the image. In one embodiment, the network may be Internet, Ethernet, Intranet, Local area network (LAN), Wide area network (WAN) or wireless network.

In some embodiment, the application programs are specifically designed to retrieve data from the computers that are in a standby or sleep mode. In these cases, the display 230 displays data from the computers (computer 1 and computer 2) even though the computers are in a standby or sleep mode.

In some embodiment, the display 230 is a touch panel. The micro control unit 226 receives commands from the touch panel 230 and transmits the commands to the computers (computer 1 or computer 2). A user can directly communicate with the computers without using the devices of the console. For example, when the data are photos stored in the computers (computer 1 and computer 2), the micro control unit 226 generates an image comprising the pictures of the photos. The display driver 228 drives the display 230 to display the image. A user can select one photo by touching the display 230. The selection is transmitted to the micro control unit 226. After determining where the selected photo is located, the micro control unit 226 communicates with the computer comprising the selected photo via the data transceiver 224 to retrieve the selected photo. The selected photo is transmitted to the KVM switch 200 via the data transceiver 224 and displayed by the display 230. A user can directly retrieve one photo from the computers directly by the display 230 without using the devices of the console (202-206).

In some embodiments, the micro control unit 226 generates an on-screen display (OSD). The display driver 228 drives the display 230 to show the OSD for expressing the work situation of the KVM switch 200. When the display 230 is a touch panel, a user can select a computer to control directly via the KVM switch 200 without using the devices of the console. A user may switch the connection between the console and the computers via the OSD in the display 230. In one embodiment, the OSD is generated when the KVM switch 200 detects a predefined input from the console. The predefined input may be hot key of the keyboard, button click combination of the mouse, or the button of the monitor.

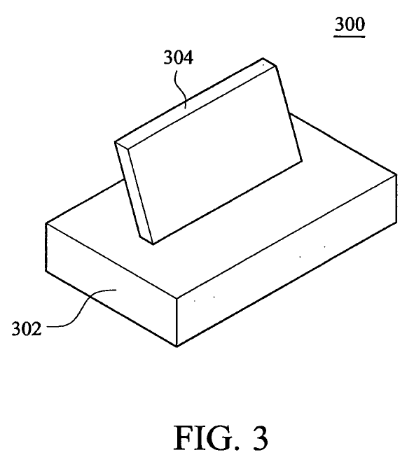

FIG. 3 illustrates the structure of the keyboard-video-mouse (KVM) switch of the invention. The KVM switch 300 further comprises a body 302. A display 304 is disposed on the body 302. A user can control a plurality of computers via the KVM switch 300. Besides receiving commands from the console and outputting video and audio signals to the console via the KVM switch 300, the computers output data to the KVM switch 300. The data transceiver of the KVM switch 300 receives the data, and the micro control unit of the KVM switch 300 analyzes and operates the received data to generate an image. The image is displayed by the display 304. In some embodiments, the display is a touch panel, and a user can communicate with the computers directly via the KVM switch 300 without using the devices of the console.

In one embodiment, the display 304 is vertically disposed on the body 302. In another embodiment, the display 304 is horizontally disposed on the body 302. In other embodiment, the display 304 is foldable and is disposed on the body 302.

While the invention has been described by way of example and in terms of embodiments, it is to be understood that the invention is not limited thereto. To the contrary, it is intended to cover various modifications and similar arrangements (as would be apparent to those skilled in the Art). Therefore, the scope of the appended claims should be accorded to the broadest interpretation so as to encompass all such modifications and similar arrangements.

What is claimed is:

1. A KVM switch, comprising:
a body;
a data transceiver receiving data from a plurality of computers;
a micro control unit, analyzing and operating the received data to generate an image; and
a display, disposed on the body, displaying the image.

2. The KVM switch of claim 1, further comprising a display driver coupled between the micro control unit and the display to drive the display to display the image generated by the micro control unit.

3. The KVM switch of claim 1, wherein each computer comprises an application program generating the data.

4. The KVM switch of claim 3, wherein the application program retrieves system information of the corresponding computer as the data.

5. The KVM switch of claim 4, wherein the image shows the system information of the computers in a list.

6. The KVM switch of claim 4, wherein the system information is CPU loading, CPU temperature, fan rotation, disc information, time, or date.

7. The KVM switch of claim 3, wherein the application program retrieves discs of the corresponding computer to get the data.

8. The KVM switch of claim 7, wherein the data retrieved from the discs are photos, emails, notes, or address books.

9. The KVM switch of claim 3, wherein the application program downloads information from a network as the data.

10. The KVM switch of claim 9, wherein the downloaded information is the weather report or the stock quotes.

11. The KVM switch of claim 1, wherein the data transceiver communicates with the computers via a USB protocol, a wireless protocol, or a serial protocol.

12. The KVM switch of claim 2, wherein the micro control unit further generates an on-screen display (OSD) and the display driver further drives the display to show the on-screen display.

13. The KVM switch of claim 1, wherein the display is a touch panel, and the micro control unit further receives commands from the touch panel and then transmits the commands to the computers.

14. The KVM switch of claim 1, further comprising a video monitor switch routing the connection between a video monitor and the computers.

15. The KVM switch of claim 1, further comprising an audio switch routing the connection between an audio device and the computers.

16. The KVM switch of claim 1, further comprising a KB/MS controller controlling the connection between a keyboard and the computers and the connection between a mouse and the computers.

17. A multi-computer system, comprising:
a plurality of computers, each comprising a data terminal and an application program generating data; and
a KVM switch, comprising:
a body;
a data transceiver coupling to the data terminals of the computers to receive the data from the computers;
a micro control unit analyzing and operating the received data to generate an image; and
a display, disposed on the body, displaying the image.

18. The multi-computer system of claim 17, wherein the application program retrieves system information of the corresponding computer as the data.

19. The multi-computer system of claim 18, wherein the image shows the system information of the computers in a list.

20. The multi-computer system of claim 17, wherein the application program retrieves discs of the corresponding computer to get the data.

21. The multi-computer system of claim 17, wherein the application program downloads information from a network as the data.

22. The multi-computer system of claim 17, wherein the data transceiver communicates with the computers via a USB protocol, a wireless protocol, or a serial protocol.

23. The multi-computer system of claim 17, wherein the display is a touch panel and the micro control unit further receives commands from the touch panel and then transmits the commands to the computers.

24. A KVM switch, comprising:
a body;
a display, disposed on the body;
a micro control unit, generating an on-screen display (OSD); and
a display driver, coupled between the micro control unit and the display to drive the display to show the on-screen display.

25. The KVM switch of claim 24, detecting a predefined input from a console to display the OSD.
